(19) United States
(12) Patent Application Publication
(10) Pub. No.: US 2021/0345598 A1
(43) Pub. Date: Nov. 11, 2021

(54) SYSTEMS AND METHODS FOR A GAME CALL HOUSING

(71) Applicant: Jonathan Russel Folmar, Cedarburg, WI (US)

(72) Inventor: Jonathan Russel Folmar, Cedarburg, WI (US)

(21) Appl. No.: 16/866,935

(22) Filed: May 5, 2020

(51) Int. Cl. A01M 31/00

(52) U.S. Cl. CPC A01M 31/004

(57) ABSTRACT

A game call can include a holder with a body molded from an elastomeric material configured to retain to a resting shape. The body can include a slot formed in an inward-facing surface of the body that extends around a cutout positioned at a front side of the body. The came call can also include a reed insert configured to be received by the holder. The reed insert can include a diaphragm configured to extend across the cutout when the reed insert is received in the holder. The holder may be configured to receive the reed insert into the body when in a stretched state, and to retain the reed insert in the body when in the resting shape.

### BACKGROUND

The disclosed system generally relates to a game call, and in particular a game call intended to be held in a user's mouth. Many different types of game calls are used to produce sounds to attract game animals. One type of game call comprises a flexible diaphragm stretched across an open-ended frame. The call is placed against the roof of the user's mouth and then various techniques may be used to produce appropriate sounds by forcing air across the diaphragm.

Because the diaphragm and the frame holding it are typically a small fraction of the size of the user's mouth, some means of retaining the call in the user's mouth may be required. One method is to sandwich the edge of the frame between two layers of tape such as the kind of tape used to secure bandages.

### SUMMARY

The present disclosure relates to a game call with a flexible holder configured to hold a sound-generating reed insert. The holder can have a unitary design that can be quickly produced using a variety of molding processes. The holder can be formed with materials that are safe for inclusion in a user's mouth, and which are sufficiently durable so that the game call can be used repeatedly without the holder being damaged.

Disclosed herein are embodiments of a holder for a game call. The game call may include a reed insert with a diaphragm supported by a frame. The holder can include a body molded from an elastomeric material configured to retain to a resting shape. The body can include an inward-facing surface that extends around a cutout positioned at a front side of the body. The holder can also include a slot formed in the inward-facing surface, and the slot can be dimensioned to receive the frame of the reed insert so that the diaphragm spans across the cutout. The body can be configured to be stretched to receive the reed insert when the body is in the stretched state, and the slot can be configured to retain the reed insert when the body is in the resting shape.

In some embodiments, the elastomeric material can be a plastisol, rubber or comparable FDA safe elastomer, and the elastomer may be suitable for inclusion in an oral cavity of a user. The slot can extend around the cutout in a U-shaped path that corresponds to the shape of the frame when the body is in the resting shape.

In some embodiments, the body can include a first front wall and a second front wall positioned on opposite sides of the cutout at the front side of the body, and the slot may extend from the first front wall to the second front wall. The first front wall and the second front wall can be configured to restrict sliding motion of the reed insert when the frame is received in the slot and the body is in the resting shape. In such an embodiment, a portion of the slot may be elongated when the body is in the stretched state so that the first front wall is further away from the second front wall than when the body is in the resting state.

In some embodiments, the slot may be bound by a top wall, a bottom wall, and a rear wall positioned between the top wall and the bottom wall. The top wall and the bottom wall can be configured to grip the frame when the frame is received in the slot. Additionally or alternatively, the frame can be coupled to the body by an ultrasonic weld. The body can be integrally formed with a skirt that extends from an outward-facing surface of the body.

Embodiments of a game call can include a holder and a reed insert configured to be received by the holder. The holder can have a body molded from an elastomeric material configured to retain to a resting shape, and may include a slot formed in an inward-facing surface of the body that extends around a cutout positioned at a front side of the body. The reed insert can include a diaphragm configured to extend across the cutout when the reed insert is received in the holder. The holder may be configured to receive the reed insert into the body when in a stretched state, and to retain the reed insert in the body when in the resting shape.

In some embodiments, the reed insert can include a frame dimensioned to fit within the slot when the holder is in the resting shape. The body may include a first front wall positioned at a first end of the slot and a second front wall positioned a second end of the slot. The first front wall and the second front wall can be configured to restrict sliding motion of the reed insert when the frame is received in the slot and the holder is in the resting shape.

In some embodiments, the reed insert can be coupled to the holder with an ultrasonic weld. Additionally or alternatively, the elastomeric material may be a plastisol or rubber elastomer.

Disclosed herein are embodiments of a method for producing a game call that can include a reed insert with a diaphragm supported by a frame. The method can include steps for molding a holder with an elastomeric material, where the holder can include a slot extending around a cutout positioned at a front side of the holder. The method can also include steps for receiving a portion of the reed insert in the slot, stretching the holder out of a resting shape into a stretched state, and capturing the reed insert in the holder by returning the holder to the resting shape.

In some embodiments, the method can further include steps for coupling the frame of the reed insert to the holder using ultrasonic welding after the step of capturing the reed insert. Additionally or alternatively, the step of molding the holder can include forming the holder using injection molding, rotational or thermoform molding.

In some embodiments, the step of receiving a portion of the reed insert may include maneuvering a first end of the frame into the slot behind a first front wall of the body. In such an embodiment, the step of stretching the holder can include stretching the body by moving a second front wall of the body away from the first front wall. The step of capturing the reed insert can include manipulating the body so that a second end of the frame is positioned in the slot behind the second front wall of the body.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a perspective view of an embodiment of a game call including a holder and a reed insert;

FIG. 2 is an exploded perspective view of the holder and reed insert of FIG. 1;

FIG. 3 is a cross section of the game call of FIG. 1 taken along section line 3-3;

FIG. 4 is an exploded perspective view of a mold assembly that may be used to produce a holder for a game call;

FIG. 5 is an assembled perspective view of the mold assembly of FIG. 4;

FIG. 6A is an exploded view of a holder produced using the mold assembly of FIG. 5;

FIG. 6B is a cross section of the holder of FIG. 6A taken along line 6B-6B;

FIG. 7A is a perspective view illustrating a step for inserting a reed insert into a holder;

FIG. 7B is a perspective view of the holder and reed insert of FIG. 7A after the holder has returned to its resting shape;

8A is a perspective view of a game call with a reed insert received in a holder;

FIG. 8B is a perspective cross section view of the holder and reed insert of FIG. 8A taken along section line 8B-8B; and

FIG. 9 is an elevation view of an ultrasonic welding system with a game call.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

Unless otherwise specified or limited, the phrases “at least one of A, B, and C,” “one or more of A, B, and C,” and the like, are meant to indicate A, or B, or C, or any combination of A, B, and/or C, including combinations with multiple instances of A, B, and/or C. Likewise, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

As used herein, unless otherwise specified or limited, the term “U-shaped” specifies a shape that includes a base portion, with at least two leg portions extending in generally similar (e.g., parallel) directions from the base portion. In some embodiments, a “U-shaped” structure can include leg portions extending from opposite ends of the base portion at substantially right angles to the base portion, with or without curved or chamfered connecting regions between the leg portions and the base portion. In some embodiments, a “U-shaped” structure can include at least one of legs of different lengths and at least one curved portion.

Embodiments of the disclosure may be further understood in reference to the figures.

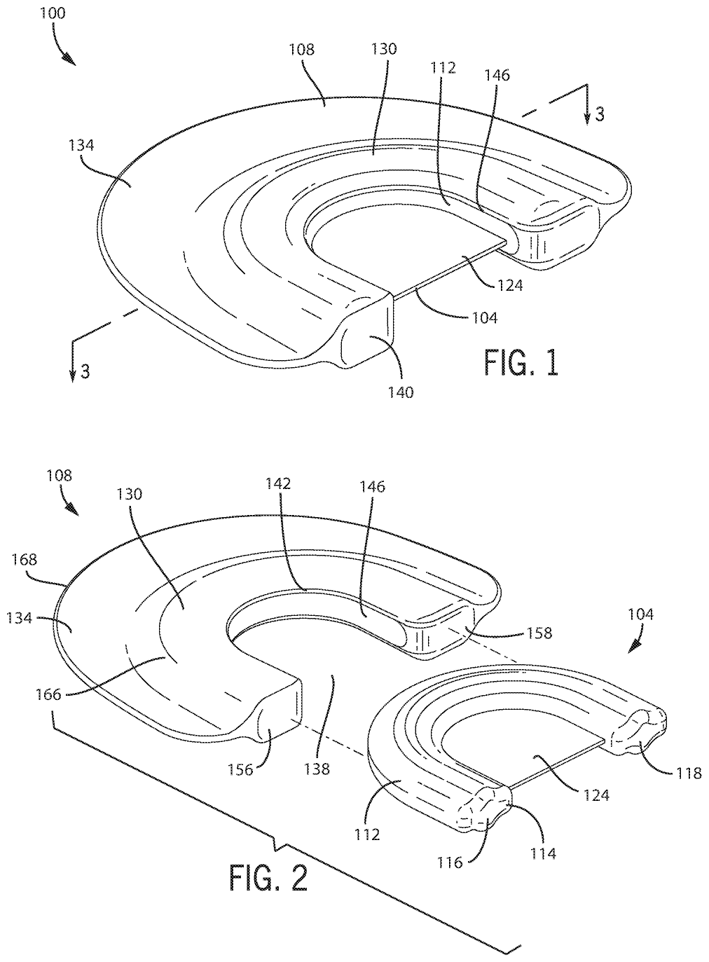

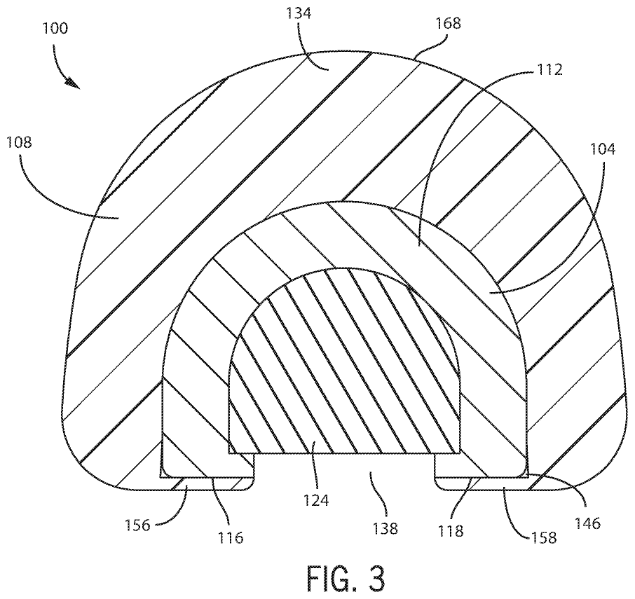

FIGS. 1 and 2 illustrate an embodiment of a game call 100 with a reed insert 104 configured to be secured in a holder 108. The reed insert 104 can include a frame 112 that is generally U-shaped and has an open front side 114. The frame 112 extends rearward from a first end 116 and a second end 118, which are spaced laterally apart from each other at the front side 114 of the frame, towards the back end that is positioned between the first and second ends 116, 118. A diaphragm 124 can be stretched across the frame 112 so that the diaphragm 124 extends across a gap between opposite sides of the frame 112. In some embodiments, the diaphragm 124 may provide a planar sheet that spans (i.e., covers or fills in) the gap.

In some embodiments, the frame 112 can include a pair of U-shaped planar halves, each being mateable with a corresponding plane of the other. The halves of the frame 112 can be secured to each other to sandwich a diaphragm 124 between the halves, thereby securing the diaphragm to the frame 112. The two halves of the frame 112 may be linked at their front ends so that the halves of the frame 112 are folded onto the diaphragm 124. Additionally, a tab positioned at the rear of one of the halves may be folded onto the other half of the frame 112, securing the two halves together. In other embodiments, however, a game call can include a reed insert that includes different components or is produced using a different method.

With continued reference to FIGS. 1 and 2, the holder 108 can include a body 130, which may be configured to receive the reed insert 104, and a skirt 134 formed around a portion of the body 130. The body 130 and the skirt 134 can be formed with an elastomeric material that is configured to return to its original resting shape after being stretched or deformed. This may be useful, for example, to allow the holder 108 to retain its original shape after being stretched and manipulated by a user. In some embodiments, the holder 108 may be formed with a thermoset material, such as a plastisol or rubber elastomer. Other embodiments of a holder 108 may be formed with at least one of another thermoset elastomer, a thermoplastic, rubber, silicone, and any other material exhibiting elastic or resilient properties. It is contemplated that the material used to form the holder 108 will be selected such that the material is suitable for use in the oral cavity of the user. In a contemplated embodiment, the material used to form the holder will be formally approved for use in the oral cavity by the Food and Drug Administration (FDA).

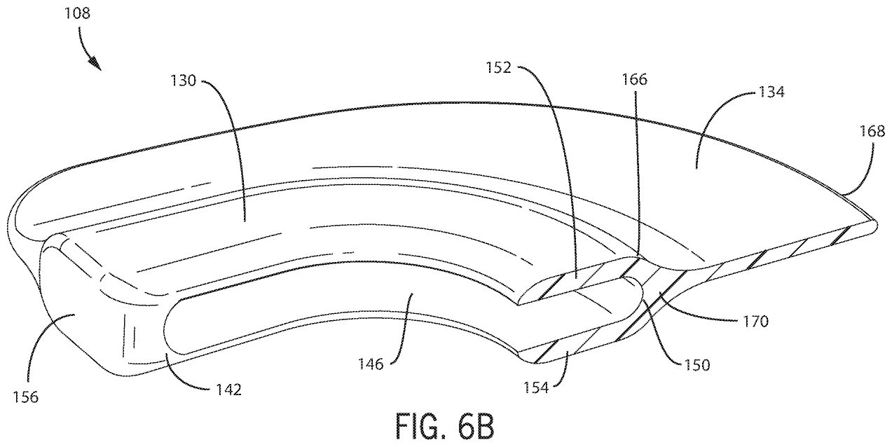

In the illustrated embodiment, a cutout 138 positioned at the front side 140 of the body 130 extends backwards towards an inward-facing surface 142 of the body 130, providing an open end on the front side 140. The inward-facing surface 142 wraps around the cutout 138 between endpoints that are positioned at the front side 140 on opposite lateral sides of the cutout 138. To accommodate the reed insert 104, the holder 108 can include an open slot 146 formed into the inward-facing surface 142. As illustrated in FIG. 6B, the slot 146 can extend into the body 130 from an opening on the inward-facing surface 142 towards a rear wall 150 of the slot 146. The top and bottom extents of the slot 146 are respectively bound by a top wall 152 and a bottom wall 154 formed on opposite vertical sides of the rear wall 150. The ends of the slot 146 are bound by a first front wall 156 and a second front wall 158, which are positioned on opposite lateral sides of the cutout 138.

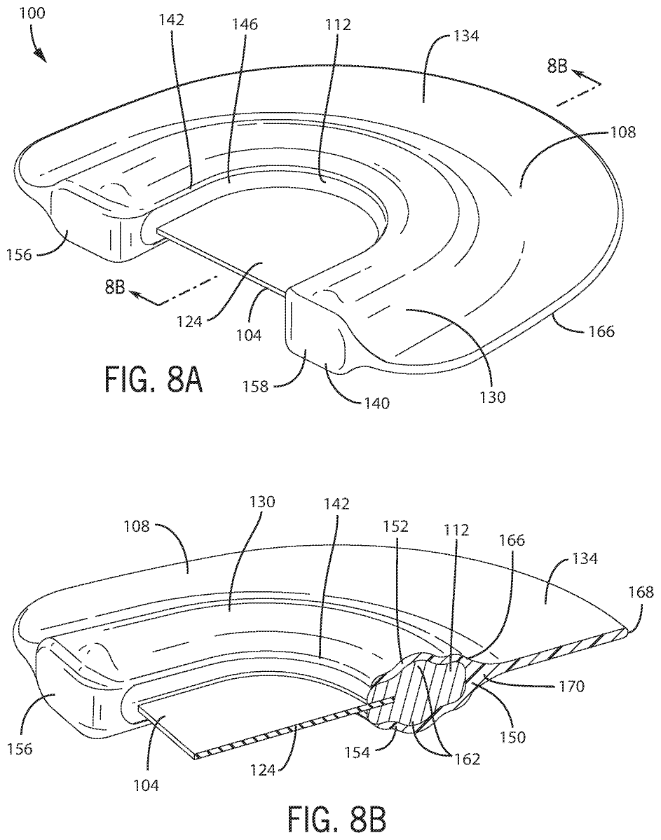

As previously mentioned, the body 130 of the holder 108 can be configured to receive the reed insert 104. As illustrated in FIG. 3, for example, the slot 146 extends around the cutout 138 in a U-shaped path with dimensions that correspond to the dimensions of the frame 112 of the reed insert 104. The body 130 can be dimensioned so that the diaphragm 124 extends out of the slot 146 and provides a continuous sheet spanning across the cutout 138 while the reed insert 104 is in the holder 108. While the frame 112 is received in the slot 146, the first end 116 of the frame 112 is positioned behind the first front wall 156 of the body 130, and the second end 118 of the frame 112 is positioned behind the second front wall 158 of the body 130. Abutment between the ends 116, 118 of the frame and the first and second front walls 156, 158 may restrict sliding movement of the reed insert 104 relative to the holder 108. This may be useful, for example, in order to prevent the reed insert 104 from sliding out of the holder 108. Additionally or alternatively, the body 130 can be configured to grip the frame 112 to apply a retention force against the removal of the reed insert 104 from the holder 108. The slot 146 can be dimensioned so that the at least one of top wall 152, the bottom wall 154, and the rear wall 150 snugly fit around the frame 112 to create friction between their surfaces. Some embodiments of a body 130 can be configured to conform to features on the surface of the frame 112. For example, as illustrated in FIG. 8B, the top and bottom walls 152, 154 can conform to and grip ridges 162 protruding from the top and bottom of the frame 112. Some embodiments of a body can be configured to conform to other features on a frame, including protrusions such as a tab, or recesses such as a groove or divot.

Referring back to FIGS. 1 and 2, the skirt 134 can extend from an outward-facing surface 166 of the body 130 to a peripheral edge 168. In the illustrated embodiments, the outward-facing surface 166 extends around the body 130 in a U-shaped path the mirrors the inward-facing surface 142. Some embodiments, however, can include a body with at least one of a different shape and size. For example, a body can be rectangular with an outward-facing surface provided by left, right, and back sides of the body. Additionally or alternatively, a body can include at least one curved side and at least one straight side. As shown in the cross-section of FIG. 6B, the skirt 134 may be integrally formed with the body 130. A tapered section 170 may provide a transition from the relatively thick body 130 to the generally planar skirt 134. Formed from the same material as the body 130, the skirt 134 can be flexible and may return to a resting shape after being manipulated by a user. This may be useful, for example, so that the skirt 134 may conform to the interior of a user's mouth.

When used, the game call 100 is placed in the mouth of a user and held above the tongue with the cutout 138 and the front walls 156, 158 of the body 130 facing outwardly towards the user's teeth. The skirt 134 can flex to contact the palate snugly, which may help to keep the game call 100 lodged in place during use. When the user blows, an airstream travels beneath and past the skirt 134, past the body 130, then beneath and past the diaphragm 124, thereby generating an audible oscillations. Various techniques may be implemented by the user to produce a variety of different sounds with the game call 100.

Having discussed the structure of a game call 100, embodiments of methods for producing the game call 100 can be discussed.

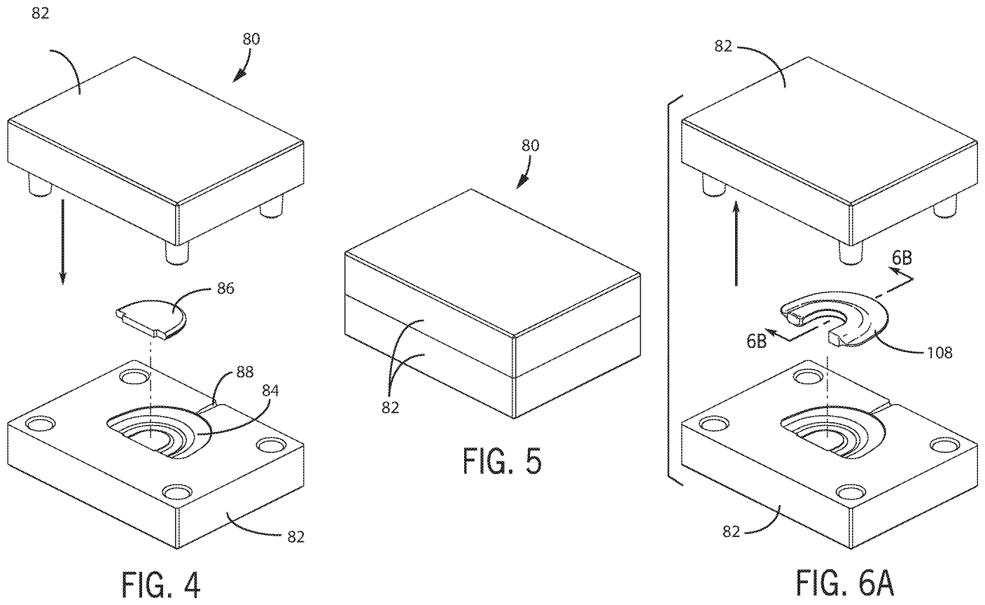

In some embodiments, the holder 108 can be formed with a molding process. Referring to FIGS. 4-6A, a mold assembly 80 can include two mold halves 82 with recesses 84 formed in their surfaces. When the two mold halves 82 are pushed together (see FIG. 5), the recesses 84 form an interior cavity in the shape of a holder 108. In some embodiments, a mold assembly 80 can include an insert 86 that is placed in the interior cavity to define features of the holder 108, such as the slot 146. Other mold assemblies may be configured to define the features of a holder without using an insert.

Once the mold assembly 80 is assembled, a liquid molding material can be poured or injected into the interior cavity through a channel 88 formed through the side of the mold halves 82. Once the interior cavity is filled, the liquid molding material is solidified in the shape of the holder 108. In embodiments in which the holder 108 is formed with plastisol or a rubber elastomer, the liquid molding fluid can include PVC and/or other polymer particles suspended in a liquid plasticizer. To solidify the fluid, the mold assembly 80 and liquid molding material contained therein are first heated to dissolve the plastic particles in the fluid, thereby turning the molding material into a gel. The gel is then allowed to cool to form a solid yet flexible holder 108. After the molding fluid has solidified, the mold halves 82 can be separated and the holder 108 may be removed from the mold assembly 80 (see FIG. 6A). As can be seen in FIG. 6B, the molding process may create a unitary holder 108 without requiring additional assembly or manufacturing steps for forming its features.

Some embodiments can use other liquid materials to form a holder, such as plastics, elastomers, or any other material for molding a solid object. The solidification process may include at least one of a heating process, a cooling process, and any other process (or combination of processes) for setting a liquid molding material into a solid object. Additionally or alternatively, a holder may be formed with a different molding or manufacturing processes. For example, a holder can be formed using at least one of injection molding, compression molding, vacuum molding and any other process for molding or otherwise manufacturing a holder.

With a holder 108 having been molded, the reed insert 104 can then be inserted into the holder 108. As previously discussed, the holder 108 can be made of a flexible material that may be stretched without permanently deforming. Once solidified in the mold assembly 80, the holder 108 will retain the original molded shape. Even after being stretched, flexed or otherwise manipulated, the holder will return to this resting shape. This may be useful, for example, in order to insert a reed insert 104 into a holder 108 that has been pre-molded in a shape configured to retain the reed insert 104 in the body 130 of the holder 108.

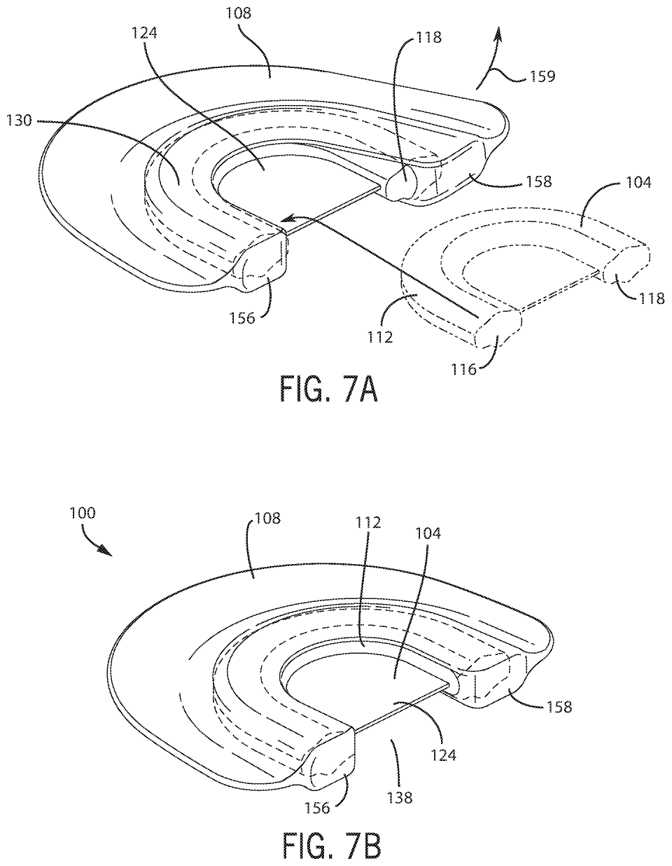

Referring to FIGS. 7A and 7B, a portion of the reed insert 104 can be inserted into the slot 146. For example, the frame 112 can be maneuvered into the slot so that the first end 116 of the frame 112 is positioned behind the first front wall 156 of the body 130. The body 130 of the holder 108 may then be stretched out of its resting shape (as shown by arrow 159) so that the entire frame 112 can be inserted into the slot 146. This may include enlarging the cutout 138 and the slot 146 by moving the second front wall 158 away from the first front wall 156 by translation, rotation or a combination of translation and rotation. The holder 108 can then be returned to its resting shape so that the frame 112 is within the slot 146 in order to capture the reed insert 104 in the holder 108. This may include manipulating at least one of the reed insert 104 and the holder 108 so that the second end 118 of the frame 112 is positioned behind the second front wall 158 of the body 130.

In some embodiments, a method for assembling a game call 100 can include at least one step that is different than those described above. For example, a holder 108 may be stretched into a stretched state before a portion of the frame 112 is inserted into the slot 146. In such an embodiment, the frame 112 can be inserted into an enlarged slot 146 before the holder 108 is returned to its resting shape with the first and second ends 116 of the frame 112 positioned behind the first and second front walls 156, 158 of the body 130, respectively. Additionally or alternatively, a method of assembling a game call 100 can include pushing the reed insert 104 into the slot 146 while the holder 108 is in its resting shape to force the body 130 to stretch and expand.

Once the reed insert 104 is captured in the holder 108, the frame 112 may be positioned entirely within the slot 146 and the diaphragm 124 may extend across the cutout 138. In some embodiments, however, a portion of the frame 112 may be exposed while the reed insert 104 is received in the holder 108, and the diaphragm my only extend across a portion of the cutout 138. Abutment between the surfaces of the slot 146 (including, for example, the front walls 156, 158, the top and bottom walls 152, 154, and the rear wall 150 of the body) and the frame 112 may restrict movement of the reed insert 104, thereby retaining the reed insert 104 in the holder 108.

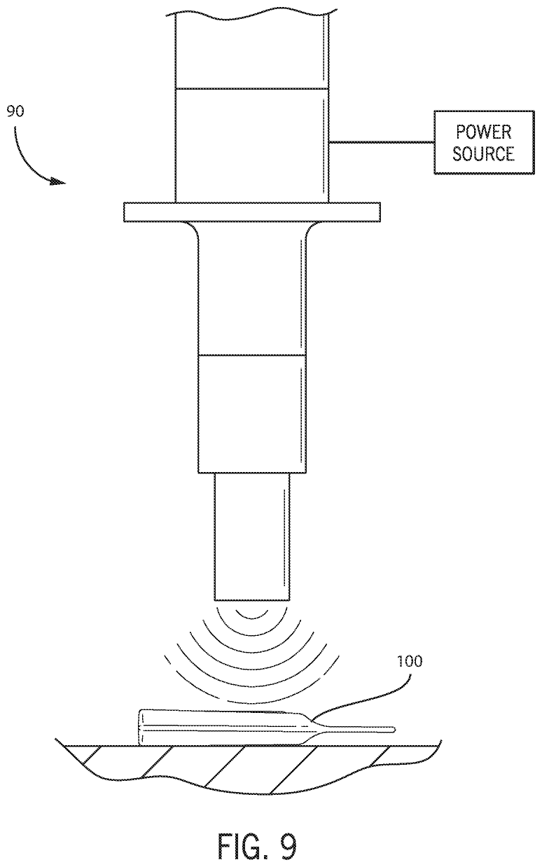

In order to further secure the reed insert 104 to the holder 108, some methods for assembling a game call 100 may include ultrasonic welding. As illustrated in FIG. 9, an ultrasonic welding system 90 can be used to couple the body 130 of the holder 108 to the reed insert 104. The ultrasonic welding process may form a bond between the surfaces of the slot 146 and the frame 112, thereby inhibiting removal of the body 130 from the frame 112. The bond between the frame 112 and the body 130 may reduce the flexibility of the holder 108 by limiting how far the body 130 may be stretched out of its resting shape. However, even when the body 130 is bonded to the frame 112, the holder 108 may be sufficiently flexible to conform to the surfaces of a user's mouth when the game call 100 is in use.

In some embodiments, different methods may be used to secure the reed insert to the holder. For example, the body of the holder may be secured to a part of the reed insert other than the frame using ultrasonic welding. Additionally or alternatively, at least one of adhesives, mechanical fasteners, and any other method for attachment may be used to secure the body to the frame. In some embodiments, the reed insert may be secure within the body without any assembly steps in addition to the steps for inserting the reed insert, and steps for bonding the frame to the surfaces of the slot may be omitted.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A holder for a game call, the game call including reed insert with a diaphragm supported by a frame, the holder comprising:
a body molded from an elastomeric material configured to retain to a resting shape, the body including an inward-facing surface that extends around a cutout positioned at a front side of the body;
a slot formed in the inward-facing surface, the slot being dimensioned to receive the frame of the reed insert so that the diaphragm spans across the cutout; and
wherein the body is configured to be stretched to receive the reed insert when the body is in the stretched state, and the slot is configured to retain the reed insert when the body is in the resting shape.

2. The holder of claim 1, wherein the elastomeric material is a plastisol or a rubber elastomer.

3. The holder of claim 2, wherein the elastomeric material is suitable for inclusion in an oral cavity of a user.

4. The holder of claim 1, wherein the slot extends around the cutout in a U-shaped path that corresponds to the shape of the frame when the body is in the resting shape.

5. The holder of claim 1, wherein the body includes a first front wall and a second front wall positioned on opposite sides of the cutout at the front side of the body, and the slot extends from the first front wall to the second front wall; and
wherein the first front wall and the second front wall restrict sliding motion of the reed insert when the frame is received in the slot and the body is in the resting shape.

6. The holder of claim 5, wherein a portion of the slot is elongated when the body is in the stretched state so that the first front wall is further away from the second front wall than when the body is in the resting state.

7. The holder of claim 1, wherein the slot is bound by a top wall, a bottom wall, and a rear wall positioned between the top wall and the bottom wall; and
wherein the top wall and the bottom wall are configured to grip the frame when the frame is received in the slot.

8. The holder of claim 1, wherein the frame is coupled to the body by an ultrasonic weld.

9. The holder of claim 1, the body is integrally formed with a skirt that extends from an outward-facing surface of the body.

10. A game call comprising:
a holder with a body molded from an elastomeric material configured to retain to a resting shape, the body including a slot formed in an inward-facing surface of the body that extends around a cutout positioned at a front side of the body;
a reed insert configured to be received by the holder, the reed insert including a diaphragm configured to extend across the cutout when the reed insert is received in the holder; and
wherein the holder is configured to receive the reed insert into the body when in a stretched state, and to retain the reed insert in the body when in the resting shape.

11. The game call of claim 10, wherein the reed insert includes a frame dimensioned to fit within the slot when the holder is in the resting shape.

12. The game call of claim 11, wherein the body includes a first front wall positioned at a first end of the slot and a second front wall positioned a second end of the slot; and
wherein the first front wall and the second front wall restrict sliding motion of the reed insert when the frame is received in the slot and the holder is in the resting shape.

13. The game call of claim 10, wherein the reed insert is coupled to the holder with an ultrasonic weld.

14. The game call of claim 10, wherein the elastomeric material is a plastisol or a rubber elastomer.

15. A method for producing a game call including a reed insert with a diaphragm supported by a frame, the method comprising steps for:
molding a holder with an elastomeric material, the holder including a slot extending around a cutout positioned at a front side of the holder;
receiving a portion of the reed insert in the slot;
stretching the holder out of a resting shape into a stretched state; and
capturing the reed insert in the holder by returning the holder to the resting shape.

16. The method of claim 15, further comprising steps for:
coupling the frame of the reed insert to the holder using ultrasonic welding after the step of capturing the reed insert.

17. The method of claim 15, wherein the step of molding the holder includes forming the holder using injection molding.

18. The method of claim 15, wherein the step of receiving a portion of the reed insert includes maneuvering a first end of the frame into the slot behind a first front wall of the body.

19. The method of claim 18, wherein the step of stretching the holder includes stretching the body by moving a second front wall of the body away from the first front wall.

20. The method of claim 19, wherein the step of capturing the reed insert includes manipulating the body so that a second end of the frame is positioned in the slot behind the second front wall of the body.
